(19) United States
(12) Patent Application Publication
(10) Pub. No.: US 2006/0088143 A1
(43) Pub. Date: Apr. 27, 2006

(54) Communications device, computer program product, and method of providing notes

(76) Inventor: Veikko Johannes Tapaninen, Oulu (FI)

Correspondence Address: Hollingsworth & Funk, LLC;Suite 125, 8009 34th Avenue South, Minneapolis, MN, 55425, US

(21) Appl. No.: 10/974,188

(22) Filed: Oct. 27, 2004

(51) Int. Cl. H04M 1/64

(52) U.S. Cl. 379/88.11; 379/67.1

(57) ABSTRACT

There is provided a communications device comprising: a processing unit for controlling functions of the device, a display for showing application views coupled to the processing unit, and an input device for giving control commands coupled to the processing unit. The processing unit is configured to detect a start of a note entering function during an active phone call; to generate a note on the basis of an input from an input device; and to associate the generated note with the phone call.

### FIELD

The invention relates to a method of providing notes in a communications device, to a communications device, and to a computer program product encoding a computer process for providing notes in a communications device.

### BACKGROUND

It is common that a user of a communications device is required to take notes during phone calls. Usually the notes are made by using a pen and a piece of paper. However, writing notes down on paper is often difficult, inconvenient, and sometimes even impossible. There may not be notepaper or pens available at the time of the phone call, for example. Further, the notepaper can easily get lost or be forgotten somewhere. Later it may also be difficult to remember when the notes were written or even to which phone calls they were related.

Sometimes it is also possible to write notes during the phone calls by using a communication device, such as Nokia Communicator 9210. During the phone call a user may write a note by selecting a function of adding notes, for example. However, these notes are not tied to the phone calls and later it may be difficult to remember which phone calls the notes were related to. The users may of course add text to the notes informing which phone calls the notes are referring to. However, this takes time and increases inconvenience to the users.

### SUMMARY OF THE INVENTION

According to an aspect of the invention, there is provided a method of providing notes in a communications device, the method comprising: detecting a start of a note entering function during an active phone call; generating a note on the basis of an input from an input device; and associating the generated note with the phone call.

According to an embodiment of the invention, there is provided a communications device comprising: a processing unit for controlling functions of the device, a display for showing application views coupled to the processing unit, and an input device for giving control commands coupled to the processing unit. The processing unit is configured to detect a start of a note entering function during an active phone call; to generate a note on the basis of an input from an input device; and to associate the generated note with the phone call.

According to an aspect of the invention, there is provided a computer program product encoding a computer process for providing notes in a communications device, the computer process comprising: detecting a start of a note entering function during an active phone call; generating a note on the basis of an input from an input device; and associating the generated note with the phone call.

According yet to another aspect of the invention, there is provided a communications device comprising: controlling means for controlling functions of the device, display means for showing application views, and input means for giving control commands. The controlling means further comprise detecting means for detecting a start of a note entering function during an active phone call; generating means for generating a note on the basis of an input from the input means; and associating means for associating the generated note with the phone call.

The embodiments of the invention provide several advantages. Notes can easily be added anytime and anywhere. The user is not dependent on availability of paper or pens. Reviewing notes later is simple, and the notes cannot get lost. It is also easy to check to which phone calls the notes are related.

### BRIEF DESCRIPTION OF THE DRAWINGS

In the following, the invention will be described in greater detail with reference to the preferred embodiments and the accompanying drawings, in which

FIG. 1 shows an example of a communications device;

FIGS. 2A and 2B illustrate examples of user interfaces of a communications device, and

FIGS. 3A and 3B illustrate examples of a method of providing notes in a communications device.

### DETAILED DESCRIPTION OF THE PREFERRED EMBODIMENTS

The embodiments of the invention are applicable to communications devices, such as a mobile station used as a terminal in telecommunication systems comprising one or more base stations and terminals communicating with the base stations, for example. The device may be used for short-range communication implemented with a Bluetooth chip, an infrared or WLAN connection, for example. The communications device is, for example, a portable telephone or another device including telecommunication means, such as a portable computer, a personal computer, a handheld computer or a smart telephone. The communications device may be a PDA (Personal Digital Assistant) device including the necessary telecommunication means for establishing a network connection, or a PDA device that can be coupled to a mobile telephone, for instance, for a network connection.

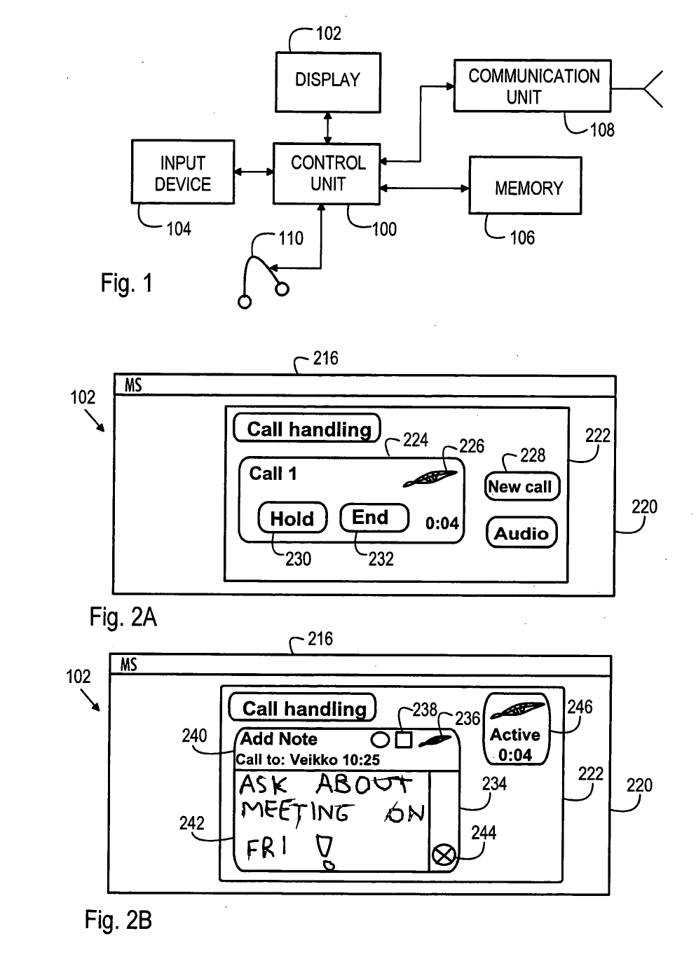

FIG. 1 shows a block diagram of the structure of a communications device. A processing unit 100, typically implemented by means of a micro-processor and software or separate components, controls the basic functions of the communications device. A user interface of the communications device comprises an input device 104 and a display 102, such as a touch screen implemented in manners known per se. The display 102 plays an increasingly important role in communications devices. The display 102 may often be the only user interface provided in the device to enable the operation of the device to be controlled. Since separate keypads in the communications devices increase the size of the devices, small electronic devices with only a touch screen as the user interface have become common. In communications devices, touch screens are often used to replace the mouse and the keypad, for example. The user gives control commands to the device by touching contact areas visible on the touch screen.

In addition, the user interface of the communications device may include a loudspeaker and a keypad part. Depending on the type of the device, there may be different and a different number of user interface parts. The communications device of FIG. 1, such as a mobile station, also includes communication means 108 that implement the functions of a mobile station and include speech and channel coders, modulators and RF parts. The communications device may also comprise an antenna, a memory 106, and a headset 110.

The functions of the communications device are controlled by means of the input device 104, such as a traditional keypad or a mouse, a hand-held locator which is operated by moving it on a surface. When using a mouse, for example, a sign or a symbol shows the location of a mouse cursor on the display 102 and often also the function running in the device, or its state. It is also possible that the display 102 itself is the input device 104 achieved by means of a touch screen such that the desired functions are selected by touching the desired objects visible on the display 102. A touch on the display 102 may be carried out by means of a pen, a stylus or a finger, for example. The input device 104 can also be achieved by using eye tracking means where detection of eye movements is used in interpreting certain control commands.

The processing unit 100 controls the functions of the user interface and is connected to the display 102 and configured to show different application views on the display 102. The processing unit 100 receives control commands from the input device 104. The input device 104 is configured to give control commands for loading application views to be shown on the display 102.

Phone calls can be carried out by using the loudspeakers and/or the headset 110 of the device in addition to the usual way of holding the device to one's ear.

In an embodiment, the processing unit 100 is configured to detect a start of a note entering function during an active phone call, to generate a note on the basis of an input from an input device 104, and to associate the generated note with the phone call. The processing unit 100 may associate the generated note with the phone call, for example, when the end of the note entering function is detected. The processing unit 100 may also be configured to display the note associated with the given phone call when selection of that note to be displayed is detected.

In an embodiment, the processing unit 100 is configured to detect the start of the note entering function on the basis of a control command received from the input device 104. It is possible that during an active phone call, an indication about a possibility of associating notes with that phone call is displayed on the display. The user of the device may give a control command for entering a note by using the input device 104, for example by touching a touch screen with a pen or a finger.

In an embodiment, the processing unit 100 is configured to add a reminder to the note associated with the given phone call for launching a reminder function referring to the given note at a given moment in time. The reminders may be used to remind the user about the given note. The reminder may be set for launching one or more specific times in the future for helping the user to recall specific notes. The processing unit 100 is configured to indicate about the notes associated with the given phone calls when the reminder functions referring to the given notes are launched. The reminder feature reminds the user to do necessary actions based on the given phone call. It is quite common that one promises to “call back tomorrow” and forgets all about that. The reminder may show the written notes and thereby remind to do what was promised.

It is possible to store the notes associated with the given phone calls to an event log for all phone calls in the memory 106 of the communications device. Thus, the user of the device may later go and check all the notes related to the phone calls by reviewing the event log. The notes associated with the given phone calls may then be displayed when selection of the given notes to be displayed from the event log for phone calls is detected.

Let us next study embodiments of the invention by means of FIGS. 2A and 2B. FIGS. 2A and 2B show displays 104 of a communications device. FIGS. 2A and 2B illustrate graphical user interfaces in an embodiment of the invention.

A display 102 can be divided into different areas, each area having specific functions. Application views are shown in the largest area 220, for example. There may be different bars 216, control blocks 234, and buttons 246 for displaying different information or menus on the display 102. There may also be control blocks for different functions other than those in these examples.

On the display 102 of FIG. 2A, a call handling window 222 can be seen in the display area 220 of the device. It is possible that the call handling window 222 appears automatically each time during a phone call. Different control blocks 228 or other windows 224 are displayed on the call handling window 222, for example. Information about the call in progress can be seen on a call window 224. There can be control blocks 230, 232 for ending and holding a phone call on the call window 224, for example.

In an embodiment, indication about a possibility to add notes to the active phone call is displayed on the call window 224 in the form of an indication block 226. The indication block 226 is in the form of a quill pen in the example of FIG. 2A. The processing unit of the communications device may detect the start of the note entering function on the basis of the user selecting the indication block 226 with his/her pen or finger, for example.

FIG. 2B shows a situation where the processing unit has detected the start of the note entering function. An add note window 240 is opened on the call handling window 222. The user may write the note to the add note window 240 by using the input device. In the example of FIG. 2B, the user has selected to use free-hand writing mode for adding the note. There can be selection buttons 238, 236 shown in the add note window 240 for choosing different ways of writing the notes. One of the selection buttons 238, 236 may, for example, open a virtual keyboard on the display 102 for entering the note. The entered note may be shown on an area for entering notes 242, for example.

Once the user has finished writing the note he/she may then choose an end button 244 for ending the note entering function, for example. Once the processing unit has detected the end of the note entering function, the generated note is associated with the active phone call. The notes may then be stored in an event log in the memory of the device, and the user may later choose to review the notes from the event log shown on the display 102.

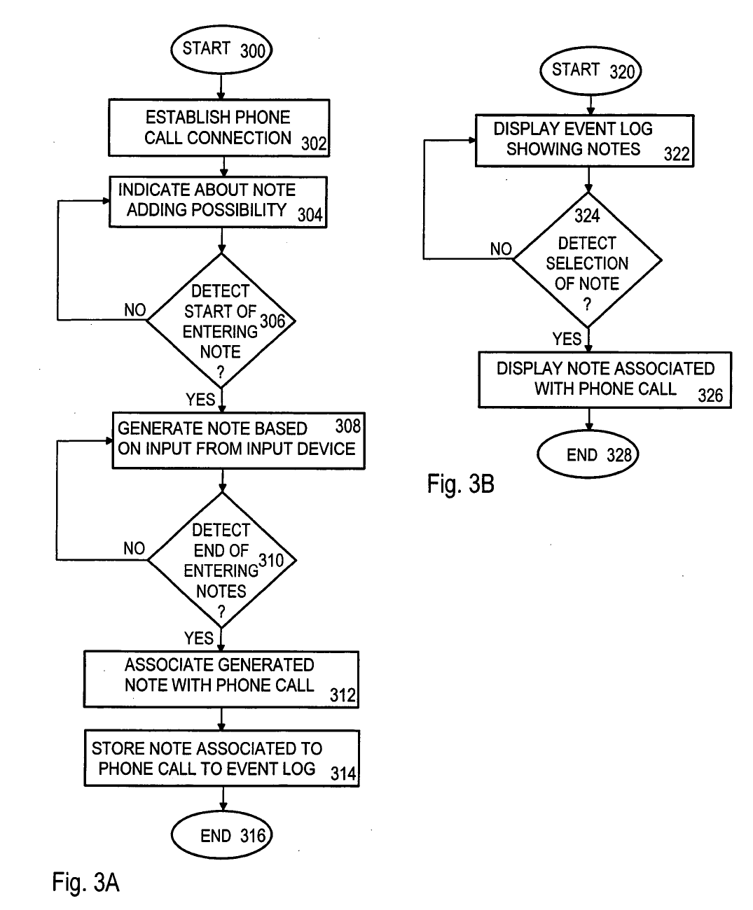

FIGS. 3A and 3B show examples of a method of providing notes in a communications device. The method shown in FIG. 3A starts in 300. In 302, a phone call connection is established. In 304, an indication about a possibility of entering notes is shown on the display. If the start of the note entering function is detected in 306, then 308 is entered. Otherwise 304 is remained. It is possible, that when the user realises that he/she needs to add a note to the active phone call, he/she starts using a loudspeaker or a headset function in the phone call. Thus the user does not have to keep the other party of the phone call waiting while adding the note. In 308, the note is generated based on the input from the input device. If the end of the note entering function is detected in 310, then 312 is entered where the generated note is associated to the active phone call. In 314, the note associated with the active phone call is stored in an event log. The method of FIG. 3A ends in 316.

The example of FIG. 3B starts in 320. It is possible that the user now wishes to review the note he/she added earlier during a phone call. In 322, the event log showing all the notes associated with the phone calls is displayed on the device. If in 324 a selection of a given note is detected, then 326 is entered where the given note associated with the phone call is displayed. The method ends in 328.

Even though the invention is described above with reference to an example according to the accompanying drawings, it is clear that the invention is not restricted thereto but it can be modified in several ways within the scope of the appended claims.

1. A method of providing notes in a communications device, the method comprising:
detecting a start of a note entering function during an active phone call;
generating a note on the basis of an input from an input device; and
associating the generated note with the phone call.

2. The method of claim 1, the method further comprising indicating about a possibility of associating notes with the active phone call on a display during the active phone call.

3. The method of claim 1, the method further comprising detecting the start of the note entering function on the basis of a control command received from the input device.

4. The method of claim 1, the method further comprising adding a reminder to the note associated with the given phone call for launching a reminder function referring to the given note at a given moment in time.

5. The method of claim 4, the method further comprising indicating about the note associated with the given phone call when the reminder function referring to the given note is launched.

6. The method of claim 1, the method further comprising displaying the note associated with the given phone call when selection of the given note to be displayed is detected.

7. The method of claim 1, the method further comprising storing the note associated with the given phone call in an event log for all phone calls.

8. The method of claim 7, the method further comprising displaying the note associated with the given phone call when selection of the given note to be displayed from the event log for phone calls is detected.

9. A communications device comprising:
a processing unit for controlling functions of the device,
a display for showing application views coupled to the processing unit, and
an input device for giving control commands coupled to the processing unit,
wherein the processing unit is configured to detect a start of a note entering function during an active phone call; to generate a note on the basis of an input from an input device; and to associate the generated note with the phone call.

10. The communications device of claim 9, wherein the processing unit is further configured to indicate about a possibility of associating notes with the active phone call on a display during the active phone call.

11. The communications device of claim 9, wherein the processing unit is further configured to detect the start of the note entering function on the basis of a control command received from the input device.

12. The communications device of claim 9, wherein on the basis of an input from the input device, the processing unit is further configured to add a reminder to the note associated with the given phone call for launching a reminder function referring to the given note at a given moment in time.

13. The communications device of claim 12, wherein the processing unit is further configured to indicate about the note associated with the given phone call when the reminder function referring to the given note is launched.

14. The communications device of claim 9, wherein the processing unit is further configured to display the note associated with the given phone call when selecting of the given note to be displayed is detected.

15. The communications device of claim 9, wherein the processing unit is further configured to store the note associated to the given phone call in an event log for all phone calls.

16. The communications device of claim 15, wherein the processing unit is further configured to display the note associated with the given phone call when selection of the given note to be displayed from the event log for phone calls is detected.

17. A computer program product encoding a computer process for providing notes in a communications device, the computer process comprising:
detecting a start of a note entering function during an active phone call;
generating a note on the basis of an input from an input device; and
associating the generated note with the phone call.

18. A communications device comprising:
controlling means for controlling functions of the device,
display means for showing application views, and
input means for giving control commands,
wherein the controlling means further comprise detecting means for detecting a start of a note entering function during an active phone call; generating means for generating a note on the basis of an input from the input means; and associating means for associating the generated note with the phone call.
